(19) United States
(12) Patent Application Publication
(10) Pub. No.: US 2023/0161284 A1
(43) Pub. Date: May 25, 2023

(54) IMAGE FORMING APPARATUS CAPABLE OF FORMING IMAGE ON SHEET WITH UNEVEN SURFACE, TRANSFER CURRENT ADJUSTMENT METHOD

(71) Applicant: KYOCERA Document Solutions Inc., Osaka (JP)

(72) Inventors: Kanako Kikuchi, Osaka (JP); Akihiro Kondo, Osaka (JP); Keisuke Oba, Osaka (JP)

(21) Appl. No.: 18/057,162

(22) Filed: Nov. 18, 2022

(30) Foreign Application Priority Data
Nov. 24, 2021 (JP) 2021-189947

(51) Int. Cl. G03G 15/00

(52) U.S. Cl. CPC G03G 15/5054

(57) ABSTRACT

An image forming apparatus includes a change processing portion, a detection processing portion, a second acquisition processing portion, and an adjustment processing portion. The change processing portion changes a transfer current when a plurality of specific toner images which each include a toner layer of C formed on an image-carrying member and a toner layer of M are each transferred to a sheet. The detection processing portion detects a specific image that corresponds to each specific toner image included in the captured image of the sheet. The second acquisition processing portion acquires, for each of detected specific images, a skewness of a histogram of gradation values of a color mixture of M and Y in pixels included in each of the specific images. The adjustment processing portion adjusts the transfer current based on: the skewness acquired for each of the specific images; and the transfer current corresponding to the skewness.

### INCORPORATION BY REFERENCE

This application is based upon and claims the benefit of priority from the corresponding Japanese Patent Application No. 2021-189947 filed on Nov. 24, 2021, the entire contents of which are incorporated herein by reference.

### BACKGROUND

The present disclosure relates to an image forming apparatus and a transfer current adjustment method.

In an image forming apparatus of an electrophotographic method, an image may be formed on a sheet with an uneven surface such as a sheet of embossed paper. Toner is hardly adhered to a lower part of the uneven surface of the sheet. As a result, in the image forming apparatus, when an image is formed on a sheet with an uneven surface, an image forming condition, such as a transfer current that is supplied to a transfer portion that transfers a toner image to the sheet, is adjusted for the purpose of restricting the degradation of the formed image.

In addition, there is known, as a related technology, an image forming apparatus that adjusts the image forming condition based on the detection result of the sheet surface shape. In this image forming apparatus, the image forming condition is adjusted based on a variation width of a voltage that is applied to a transfer portion connected to a constant current power supply when a sheet passes through a position where a toner image is transferred to the sheet by the transfer portion.

### SUMMARY

An image forming apparatus according to an aspect of the present disclosure includes a transfer portion, a transfer processing portion, a change processing portion, a first acquisition processing portion, a detection processing portion, a second acquisition processing portion, and an adjustment processing portion. The transfer portion transfers a toner image formed on an image-carrying member to a sheet. The transfer processing portion, by using the transfer portion, sequentially transfers, to the sheet, a plurality of specific toner images which each include: a first toner layer of a first color formed on the image-carrying member; and a second toner layer of a second color formed on the first toner layer, wherein the first color is any one of colors C, M, and Y, and the second color is any one of the colors C, M, and Y and is different from the first color. The change processing portion changes a current value of a transfer current that is supplied to the transfer portion, each time a specific toner image is transferred by the transfer processing portion. The first acquisition processing portion acquires a captured image of the sheet. The detection processing portion detects a specific image that corresponds to each specific toner image included in the captured image of the sheet acquired by the first acquisition processing portion. The second acquisition processing portion acquires, for each of specific images detected by the detection processing portion, a skewness of a histogram of gradation values of a color mixture of the second color and a third color in pixels included in each of the specific images detected by the detection processing portion, the third color being a color different from the first color and the second color among the colors C, M, and Y. The adjustment processing portion adjusts the transfer current based on: the skewness acquired by the second acquisition processing portion for each of the specific images; and a current value of the transfer current corresponding to the skewness.

A transfer current adjustment method according to another aspect of the present disclosure is executed in an image forming apparatus including a transfer portion that transfers a toner image formed on an image-carrying member to a sheet, and includes a transfer step, a change step, a first acquisition step, a detection step, a second acquisition step, and an adjustment step. In the transfer step, a plurality of specific toner images are sequentially transferred, by using the transfer portion, to the sheet, wherein each of the plurality of specific toner images includes: a first toner layer of a first color formed on the image-carrying member; and a second toner layer of a second color formed on the first toner layer, the first color being any one of colors C, M, and Y, the second color being any one of the colors C, M, and Y and different from the first color. In the change step, a current value of a transfer current that is supplied to the transfer portion is changed each time a specific toner image is transferred in the transfer step. In the first acquisition step, a captured image of the sheet is acquired. In the detection step, a specific image that corresponds to each specific toner image included in the captured image of the sheet acquired in the first acquisition step, is detected. In the second acquisition step, a skewness of a histogram of gradation values of a color mixture of the second color and a third color in pixels included in each of the specific images detected in the detection step, is acquired for each of specific images detected in the detection step, the third color being a color different from the first color and the second color among the colors C, M, and Y. In the adjustment step, the transfer current is adjusted based on: the skewness acquired in the second acquisition step for each of the specific images; and a current value of the transfer current corresponding to the skewness.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-section diagram showing a configuration of an image forming apparatus according to an embodiment of the present disclosure.

FIG. 2 is a block diagram showing a system configuration of the image forming apparatus according to the embodiment of the present disclosure.

FIG. 3 is a cross-section diagram showing a configuration of an image forming portion of the image forming apparatus according to the embodiment of the present disclosure.

FIG. 4 is a diagram showing an example of a histogram acquired by the image forming apparatus according to the embodiment of the present disclosure.

FIG. 5 is a diagram showing an example of the histogram acquired by the image forming apparatus according to the embodiment of the present disclosure.

FIG. 6 is a diagram showing relationship between an unevenness depth level and a secondary transfer current acquired by the image forming apparatus according to the embodiment of the present disclosure.

FIG. 7 is a flowchart showing an example of a transfer current adjustment process executed by the image forming apparatus according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Configuration of Image Forming Apparatus 100]

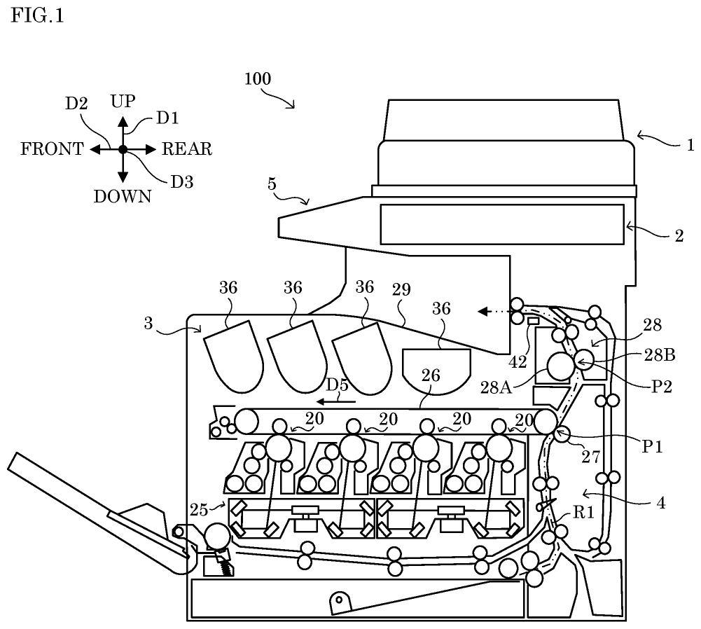

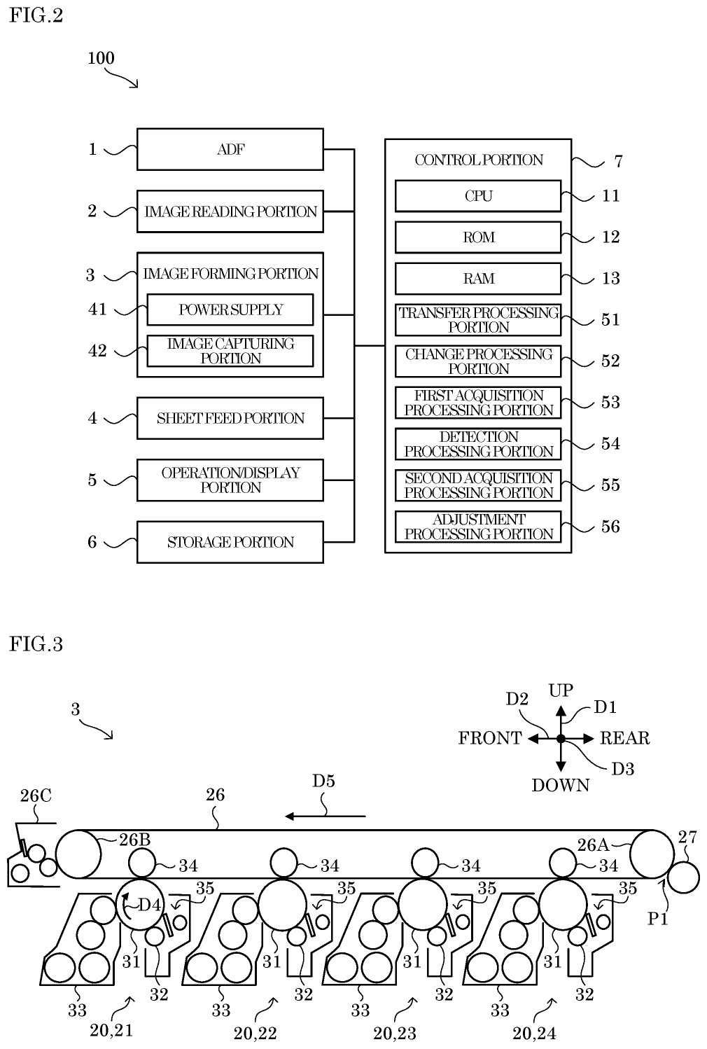

First, a description is given of a configuration of an image forming apparatus 100 according to an embodiment of the present disclosure with reference to FIG. 1 and FIG. 2.

It is noted that, for the sake of explanation, a vertical direction in a state where the image forming apparatus 100 is usably installed (the state shown in FIG. 1), is defined as an up-down direction D1. In addition, a front-rear direction D2 is defined on the supposition that the left side of the image forming apparatus 100 in FIG. 1 is a front side (front). Furthermore, a left-right direction D3 is defined based on the image forming apparatus 100 in the installation state viewed from the front side.

The image forming apparatus 100 is a multifunction peripheral having a plurality of functions such as a scan function for reading image data from a document sheet, a print function for forming an image based on image data, a facsimile function, and a copy function. It is noted that the present disclosure is applicable to an image forming apparatus such as a printer, a facsimile apparatus, and a copier.

As shown in FIG. 1 and FIG. 2, the image forming apparatus 100 includes an ADF (Auto Document Feeder) 1, an image reading portion 2, an image forming portion 3, a sheet feed portion 4, an operation/display portion 5, a storage portion 6, and a control portion 7.

The ADF 1 conveys a document sheet that is a reading target of the scan function. The ADF 1 includes a document sheet setting portion, a plurality of conveyance rollers, a document sheet pressing member, and a sheet discharge portion.

The image reading portion 2 realizes the scan function. The image reading portion 2 includes a document sheet table, a light source, a plurality of mirrors, an optical lens, and a CCD (Charge Coupled Device).

The image forming portion 3 realizes the print function. Specifically, the image forming portion 3 forms, by an electrophotographic method, a color or monochrome image on a sheet supplied from the sheet feed portion 4.

The sheet feed portion 4 supplies a sheet to the image forming portion 3. The sheet feed portion 4 includes a sheet feed cassette, a manual feed tray, and a plurality of conveyance rollers.

The operation/display portion 5 is a user interface of the image forming apparatus 100. The operation/display portion 5 includes a display portion and an operation portion. The display portion is, for example, a liquid crystal display and displays various types of information in response to control instructions from the control portion 7. The operation portion is composed of, for example, operation keys or a touch panel through which various types of information are input to the control portion 7 in response to user operations.

The storage portion 6 is a nonvolatile storage device. For example, the storage portion 6 is a storage device such as: a nonvolatile memory such as a flash memory or an EEPROM; an SSD (Solid State Drive); or an HDD (Hard Disk Drive).

The control portion 7 comprehensively controls the image forming apparatus 100. As shown in FIG. 2, the control portion 7 includes a CPU 11, a ROM 12, and a RAM 13. The CPU 11 is a processor that executes various calculation processes. The ROM 12 is a nonvolatile storage device in which various information such as control programs for causing the CPU 11 to execute various processes are preliminarily stored. The RAM 13 is a volatile or nonvolatile storage device that is used as a temporary storage memory (working area) for the various processes executed by the CPU 11. The CPU 11 comprehensively controls the image forming apparatus 100 by executing the various control programs preliminarily stored in the ROM 12.

It is noted that the control portion 7 may be a control portion provided independently of a main control portion that comprehensively controls the image forming apparatus 100. In addition, the control portion 7 may be formed as an electronic circuit such as an integrated circuit (ASIC).

[Configuration of Image Forming Portion 3]

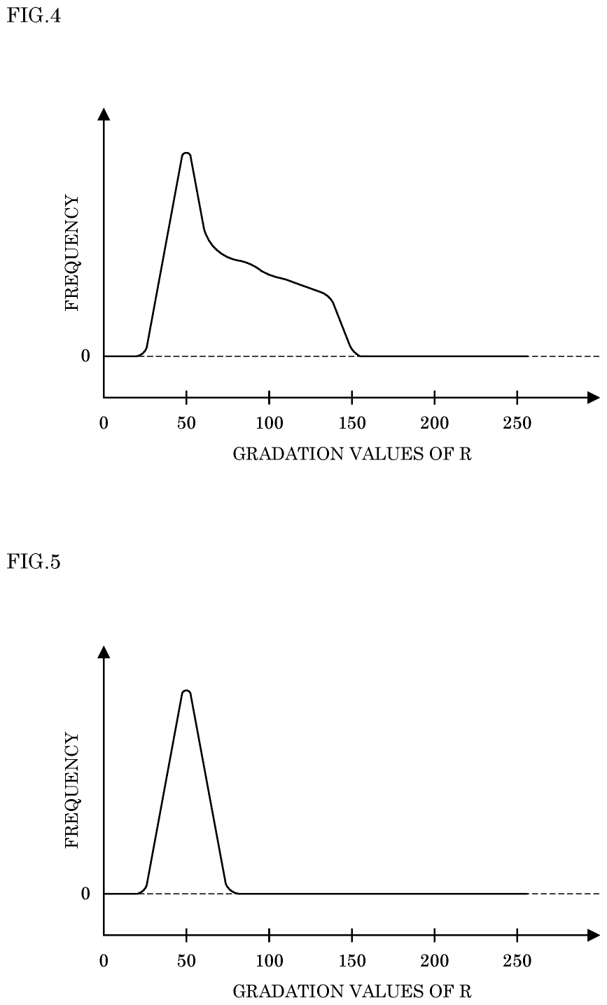

Next, a configuration of the image forming portion 3 is described with reference to FIG. 1 to FIG. 3. Here, FIG. 3 is a cross-section diagram showing a configuration of a plurality of image forming units 20, an intermediate transfer belt 26, and a secondary transfer roller 27.

As shown in FIG. 1, the image forming portion 3 includes four image forming units 20, a laser scanning unit 25, the intermediate transfer belt 26, the secondary transfer roller 27, a fixing device 28, and a sheet discharge tray 29. In addition, as shown in FIG. 2, the image forming portion 3 includes a power supply 41 and an image capturing portion 42.

Of the four image forming units 20, an image forming unit 21 (see FIG. 3) forms a Y (yellow) toner image. Of the four image forming units 20, an image forming unit 22 (see FIG. 3) forms a C (cyan) toner image. Of the four image forming units 20, an image forming unit 23 (see FIG. 3) forms an M (magenta) toner image. Of the four image forming units 20, an image forming unit 24 (see FIG. 3) forms a K (black) toner image. That is, the image forming portion 3 forms an image on a sheet using toners of colors C, M, Y, and K. As shown in FIG. 1 and FIG. 3, the four image forming units 20 are arranged in order of yellow, cyan, magenta, and black from the front side of the image forming apparatus 100 along the front-rear direction D2.

As shown in FIG. 3, each of the image forming units 20 includes a photoconductor drum 31, a charging roller 32, a developing device 33, a primary transfer roller 34, and a drum cleaning portion 35. In addition, each of the image forming units 20 includes a toner container 36 shown in FIG. 1.

On a surface of the photoconductor drum 31, an electrostatic latent image is formed. For example, the photoconductor drum 31 has a photosensitive layer formed from amorphous silicon. Upon receiving a rotational driving force supplied from a motor (not shown), the photoconductor drum 31 rotates in a rotation direction D4 shown in FIG. 3. This allows the photoconductor drum 31 to convey the electrostatic latent image formed on its surface.

Upon receiving a supply of a predetermined charging voltage, the charging roller 32 electrically charges the surface of the photoconductor drum 31. For example, the charging roller 32 charges the surface of the photoconductor drum 31 to a positive polarity. The surface of the photoconductor drum 31 charged by the charging roller 32 is irradiated with light that is emitted from the laser scanning unit 25 based on image data. This forms an electrostatic latent image on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stir developer stored inside the developing device 33, wherein the developer includes toner and carrier. As the developer is stirred, the toner included in the developer makes friction with the carrier included in the developer, and the toner is charged to the positive polarity. The magnet roller draws up the developer stirred by the pair of stirring members and supplies the toner included in the developer to the developing roller. The developing roller conveys the toner supplied from the magnet roller to a position facing the photoconductor drum 31. In addition, upon receiving an application of a predetermined developing bias voltage, the developing roller supplies the toner conveyed to the position facing the photoconductor drum 31, to the photoconductor drum 31. This allows the electrostatic latent image formed on the surface of the photoconductor drum 31 to be visualized (developed). It is noted that the toner is supplied from the toner container 36 to the developing device 33.

The primary transfer roller 34, upon receiving a supply of a predetermined primary transfer current, transfers a toner image formed on the surface of the photoconductor drum 31 to an outer peripheral surface of the intermediate transfer belt 26. As shown in FIG. 3, the primary transfer roller 34 is disposed to face the photoconductor drum 31 across the intermediate transfer belt 26.

The drum cleaning portion 35 removes the toner that has remained on the surface of the photoconductor drum 31 after the transfer of the toner image by the primary transfer roller 34.

The laser scanning unit 25 emits light based on the image data, to the surfaces of the photoconductor drums 31 of the image forming units 20.

The intermediate transfer belt 26 is a belt member of an endless shape to which toner images formed on the surfaces of the photoconductor drums 31 of the image forming units 20 are transferred. The intermediate transfer belt 26 is stretched by a drive roller 26A (see FIG. 3) and a stretch roller 26B (see FIG. 3) with a predetermined tension. The intermediate transfer belt 26 rotates in a rotation direction D5 shown in FIG. 3 when the drive roller 26A rotates upon receiving a rotational driving force supplied from a motor (not shown). This allows the intermediate transfer belt 26 to convey the toner image formed on the outer peripheral surface thereof to a secondary transfer position P1 (see FIG. 3) where the toner image is transferred to a sheet by the secondary transfer roller 27. It is noted that the outer peripheral surface of the intermediate transfer belt 26 from which the toner image has been transferred by the secondary transfer roller 27 is cleaned by a belt cleaning portion 26C shown in FIG. 3.

The secondary transfer roller 27 transfers the toner image that has been transferred to the outer peripheral surface of the intermediate transfer belt 26, to a sheet supplied from the sheet feed portion 4. As shown in FIG. 3, the secondary transfer roller 27 is disposed to face the drive roller 26A across the intermediate transfer belt 26. The secondary transfer roller 27 is biased by a biasing member (not shown) towards the drive roller 26A so that the secondary transfer roller 27 comes in contact with the intermediate transfer belt 26 with a predetermined nip pressure. The secondary transfer roller 27, at the secondary transfer position P1 (see FIG. 3) where it comes in contact with the intermediate transfer belt 26, transfers the toner image formed on the intermediate transfer belt 26 to the sheet. The secondary transfer roller 27 is an example of a transfer portion of the present disclosure. In addition, the intermediate transfer belt 26 is an example of an image-carrying member of the present disclosure.

The fixing device 28 fixes the toner image transferred to the sheet by the secondary transfer roller 27, to the sheet. As shown in FIG. 1, the fixing device 28 includes a fixing roller 28A and a pressure roller 28B. The fixing roller 28A is heated to a predetermined fixing temperature by a heater (not shown). The fixing roller 28A is rotated at a predetermined speed. The pressure roller 28B is biased by a biasing member (not shown) towards the fixing roller 28A so that the pressure roller 28B comes in contact with the fixing roller 28A with a predetermined nip pressure. Between the fixing roller 28A and the pressure roller 28B is formed a fixing nip portion P2 (see FIG. 1) that heats and pressurizes a sheet. The toner image transferred to the sheet is heated and pressurized so as to be fixed to the sheet when the sheet passes through the fixing nip portion P2. The fixing device 28 is an example of a fixing portion of the present disclosure.

The sheet to which the toner image has been fixed by the fixing device 28 is discharged to the sheet discharge tray 29.

The power supply 41 is a constant current power supply that supplies a secondary transfer current having a predetermined current value to the secondary transfer roller 27. Specifically, the power supply 41 supplies the secondary transfer current having a current value set by the control portion 7. For example, the secondary transfer current is a current of a negative polarity. The secondary transfer current is an example of a transfer current of the present disclosure.

The image capturing portion 42 captures an image of a sheet that has been conveyed via the secondary transfer position P1 (see FIG. 1) where the toner image is transferred to a sheet by the secondary transfer roller 27. In other words, the image capturing portion 42 reads an image of a sheet that has been conveyed via the secondary transfer position P1. Specifically, the image capturing portion 42 captures the image of the sheet at a downstream of the secondary transfer position P1 in a sheet conveyance path R1 (see the two-dot chain line with an arrow shown in FIG. 1) that extends from the sheet feed cassette to the sheet discharge tray 29 via the secondary transfer position P1 (see FIG. 1) and the fixing nip portion P2 (see FIG. 1). For example, as shown in FIG. 1, the image capturing portion 42 is disposed at a downstream of the fixing nip portion P2 in the conveyance path R1. The secondary transfer position P1 is an example of a transfer position of the present disclosure. It is noted that the image capturing portion 42 may be disposed at an upstream of the fixing nip portion P2 in the conveyance path R1.

For example, the image capturing portion 42 is a CIS (Contact Image Sensor) that includes a light emitting portion and a light receiving portion. The light emitting portion emits light toward a surface of a sheet that is conveyed along the conveyance path R1. The light receiving portion receives the light that has been emitted from the light emitting portion and reflected on the surface of the sheet, and outputs an electric signal that corresponds to an amount of received light.

The electric signal output from the light receiving portion of the image capturing portion 42 is converted into a digital signal (image data) by an analog front-end circuit (not shown). For example, the analog front-end circuit converts the electric signal output from the light receiving portion of the image capturing portion 42 into image data that represents colors of the pixels by R, G, and B of 256 gradations. The image data output from the analog front-end circuit is input to the control portion 7.

Meanwhile, in the image forming apparatus 100, an image may be formed on a sheet with an uneven surface such as a sheet of embossed paper. The toner is hardly adhered to a lower part of the uneven surface of the sheet. As a result, in the image forming apparatus 100, when an image is formed on a sheet with an uneven surface, an image forming condition such as the secondary transfer current is adjusted for the purpose of restricting the degradation of the formed image.

In addition, there is known, as a related technology, an image forming apparatus that adjusts the image forming condition based on the detection result of the sheet surface shape. In this image forming apparatus, the image forming condition is adjusted based on a variation width of a voltage that is applied to a transfer portion connected to a constant current power supply, when a sheet passes through a position where a toner image is transferred to the sheet by the transfer portion.

Here, when the secondary transfer current is adjusted based on the detection result of the sheet surface shape for the purpose of restricting the degradation of the formed image, the secondary transfer current may become excessive. When the secondary transfer current is excessive, an abnormal image including what is called white spots may be generated in the toner image transferred to the sheet.

On the other hand, as described in the following, the image forming apparatus 100 according to the embodiment of the present disclosure can restrict the degradation of the formed image, as well as restrict the generation of the abnormal image, when an image is formed on a sheet with an uneven surface.

[Configuration of Control Portion 7]

Next, a configuration of the control portion 7 is described with reference to FIG. 2.

As shown in FIG. 2, the control portion 7 includes a transfer processing portion 51, a change processing portion 52, a first acquisition processing portion 53, a detection processing portion 54, a second acquisition processing portion 55, and an adjustment processing portion 56.

Specifically, a transfer current adjustment program for causing the CPU 11 to function as the above-described portions is preliminarily stored in the ROM 12 of the control portion 7. The CPU 11 functions as the above-described portions by executing the transfer current adjustment program stored in the ROM 12.

It is noted that the transfer current adjustment program may be recorded on a non-transitory computer-readable recording medium such as a CD, a DVD, or a flash memory, and may be read from the recording medium and installed in a storage device such as the storage portion 6. In addition, a part or all of the transfer processing portion 51, the change processing portion 52, the first acquisition processing portion 53, the detection processing portion 54, the second acquisition processing portion 55, and the adjustment processing portion 56 may be composed of an electronic circuit such as an integrated circuit (ASIC).

The transfer processing portion 51 uses the secondary transfer roller 27 to sequentially transfer, to a sheet, a plurality of specific toner images which each include: a first toner layer of a first color formed on the intermediate transfer belt 26; and a second toner layer of a second color formed on the first toner layer, wherein the first color is any one of colors C, M, and Y, and the second color is any one of the colors C, M, and Y and is different from the first color.

For example, the first toner layer is a toner image of C (cyan). In addition, the second toner layer is a toner image of M (magenta). In this case, the first color is C (cyan), and the second color is M (magenta). In addition, the specific toner image is a toner image of B (blue) that is a color mixture of the first color and the second color.

For example, in the image forming apparatus 100, first image data that is used by the image forming unit 22 to form a plurality of first toner layers is preliminarily stored in the storage portion 6. The first image data includes a plurality of first images that correspond to the plurality of first toner layers formed on the intermediate transfer belt 26 by the image forming unit 22. For example, each of the first images is a rectangular image of a predetermined size. In addition, each of the first images is a single-color image of C (cyan) having a predetermined specific density.

In addition, in the image forming apparatus 100, second image data that is used by the image forming unit 23 to form a plurality of second toner layers is preliminarily stored in the storage portion 6. The second image data includes a plurality of second images that correspond to the plurality of second toner layers formed by the image forming unit 23 on the first toner layers, respectively. For example, each of the second images has the same shape as each of the first images. In addition, each of the second images is a single-color image of M (magenta) having the specific density.

The transfer processing portion 51 sequentially transfers the plurality of specific toner images to a sheet by using the image forming unit 22, the image forming unit 23, the laser scanning unit 25, the intermediate transfer belt 26, the secondary transfer roller 27, the sheet feed portion 4, the first image data, and the second image data. Specifically, the transfer processing portion 51 forms the plurality of first toner layers in alignment along a rotation direction D4 (see FIG. 3) on the photoconductor drum 31 of the image forming unit 22, and sequentially transfers the plurality of first toner layers onto the intermediate transfer belt 26. In addition, the transfer processing portion 51 forms the plurality of second toner layers in alignment along the rotation direction D4 (see FIG. 3) on the photoconductor drum 31 of the image forming unit 23, and sequentially transfers the plurality of second toner layers onto the plurality of first toner layers formed on the intermediate transfer belt 26, respectively. This forms a plurality of specific toner images in alignment along a rotation direction D5 (see FIG. 3) on the intermediate transfer belt 26. Subsequently, the transfer processing portion 51 sequentially transfers the plurality of specific toner images from the intermediate transfer belt 26 to a sheet conveyed by the sheet feed portion 4. This forms, on the sheet, a plurality of toner images in each of which the layers of the specific toner image are arranged upside down.

For example, when a predetermined conveyance timing arrives, the transfer processing portion 51 causes a sheet stored in the sheet feed cassette to be conveyed along the conveyance path R1. Subsequently, the transfer processing portion 51 sequentially transfers the plurality of specific toner images to the sheet that is conveyed upon the arrival of the conveyance timing.

For example, the conveyance timing is a timing when an instruction to execute a print process for forming an image on a sheet has been input. It is noted that the conveyance timing may be a timing when a predetermined user operation has been performed on the operation/display portion 5.

The change processing portion 52 changes the current value of the secondary transfer current that is supplied to the secondary transfer roller 27, each time a specific toner image is transferred by the transfer processing portion 51.

For example, the change processing portion 52 increases, in units of a predetermined reference amount, the current value of the secondary transfer current that is supplied from the power supply 41, each time a specific toner image is transferred by the transfer processing portion 51. For example, the reference amount is 10 μA (microampere).

It is noted that the change processing portion 52 may decrease, in units of the reference amount, the current value of the secondary transfer current that is supplied from the power supply 41, each time a specific toner image is transferred by the transfer processing portion 51. In addition, each time a specific toner image is transferred by the transfer processing portion 51, the change processing portion 52 may change the current value of the secondary transfer current that is supplied from the power supply 41, to a current value predetermined for each specific toner image in an order of transfer.

The first acquisition processing portion 53 acquires a captured image of a sheet.

Specifically, the first acquisition processing portion 53 acquires, by using the image capturing portion 42, the captured image of the sheet to which the plurality of specific toner images have been transferred sequentially by the transfer processing portion 51.

It is noted that the first acquisition processing portion 53 may acquire the captured image of the sheet by using the image reading portion 2. For example, when a predetermined user operation is received after a sheet to which the plurality of specific toner images have been sequentially transferred by the transfer processing portion 51 is discharged to the sheet discharge tray 29, the first acquisition processing portion 53 may use the image reading portion 2 to capture an image of a sheet that is placed on the document sheet table or a sheet that is conveyed by the ADF 1.

The detection processing portion 54 detects a specific image that corresponds to each specific toner image included in the captured image of the sheet acquired by the first acquisition processing portion 53.

For example, the detection processing portion 54 detects, as the specific image, a colored area (an area of a color that is different from a base color of the sheet) having the same shape as the specific toner image included in the captured image of the sheet.

The second acquisition processing portion 55 acquires, for each of specific images detected by the detection processing portion 54, a skewness of a histogram of gradation values of a color mixture of the second color and a third color in the pixels included in each of the specific images detected by the detection processing portion 54, the third color being a color different from the first color and the second color among colors C, M, and Y.

For example, when the first color is C (cyan) and the second color is M (magenta), the third color is Y (yellow). In this case, the color mixture of the second color and the third color is R (red).

For example, the second acquisition processing portion 55 acquires a histogram of gradation values of R (red) that indicates an appearance frequency for each gradation value of R in the specific image, based on gradation values of R of the pixels included in the specific image detected by the detection processing portion 54. Specifically, the second acquisition processing portion 55 acquires the histogram of gradation values of R by totaling, for each gradation value of R, the number of appearances of a pixel having a gradation value of R in the specific image. Subsequently, the second acquisition processing portion 55 calculates the skewness of the histogram based on the acquired histogram.

Here, FIG. 4 and FIG. 5 show examples of the histogram of gradation values of R acquired by the second acquisition processing portion 55.

FIG. 4 shows an example of the histogram of gradation values of R acquired by the second acquisition processing portion 55 when the specific image indicates the specific toner image transferred to a first sheet having an uneven surface. The first sheet is a sheet whose surface includes a flat part and a plurality of recesses.

In addition, FIG. 5 shows an example of the histogram of gradation values of R acquired by the second acquisition processing portion 55 when the specific image indicates the specific toner image transferred to a second sheet having an even surface.

As shown in FIG. 5, when the specific image indicates the specific toner image transferred to the second sheet, the skewness of the histogram of gradation values of R is substantially 0 (zero).

On the other hand, as shown in FIG. 4, when the specific image indicates the specific toner image transferred to the first sheet, the skewness of the histogram of gradation values of R is a value of the positive side. The value becomes higher as the difference in height between the flat part and the recesses of the first sheet becomes larger. In addition, the value becomes higher as the current value of the secondary transfer current becomes lower. This is because the transfer of the first layer to the recesses tends to be insufficient since the distance to the recesses from the first layer is larger than that from the second layer, and the second toner layer transferred to the sheet tends to be exposed correspondingly.

The adjustment processing portion 56 adjusts the secondary transfer current based on: the skewness acquired by the second acquisition processing portion 55 for each specific image; and the current value of the secondary transfer current corresponding to the skewness.

For example, each time the second acquisition processing portion 55 acquires a skewness, the adjustment processing portion 56 determines the unevenness depth level of sheet corresponding to the skewness. For example, in the image forming apparatus 100, the unevenness depth level is determined as one of six levels from level 1 (most shallow) to level 6 (most deep) depending on the height of the skewness. It is noted that when the difference in sheet surface height is large, the skewness acquired by the second acquisition processing portion 55 may be a value of the negative side. In this case, the adjustment processing portion 56 may determine the unevenness depth level as the maximum (level 6).

In addition, the adjustment processing portion 56 sets, as a new current value of the secondary transfer current, the lowest current value among current values of the secondary transfer current for the unevenness depth level “1” corresponding to the skewness acquired by the second acquisition processing portion 55.

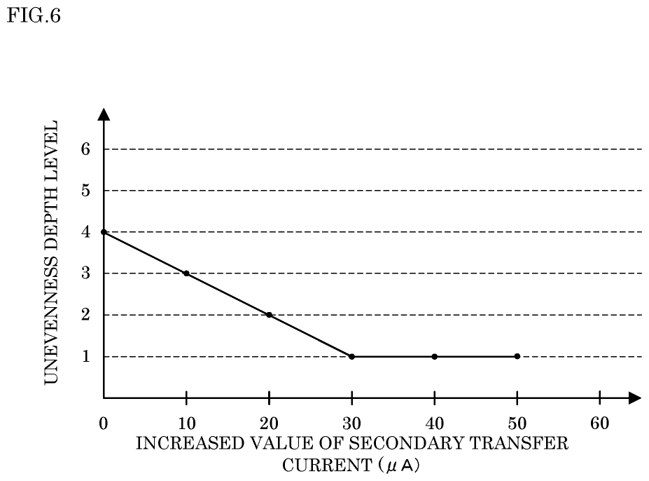

Here, FIG. 6 shows an example of relationship between the unevenness depth level corresponding to the skewness acquired by the second acquisition processing portion 55 and the current value of the secondary transfer current. FIG. 6 shows an example of relationship between the unevenness depth level and the current value of the secondary transfer current in a case where six specific toner images are transferred to the first sheet, and the current value of the secondary transfer current is increased in units of 10pA (microampere) from a reference current value each time a specific toner image is transferred. In the example shown in FIG. 6, a current value obtained by adding 30 μA (microampere) to the reference current value is set as a new current value of the secondary transfer current.

It is noted that the adjustment processing portion 56 may set, as a new current value of the secondary transfer current, the lowest current value among current values of the secondary transfer current for a case where the skewness acquired by the second acquisition processing portion 55 is equal to or lower than a predetermined reference value.

[Transfer Current Adjustment Process]

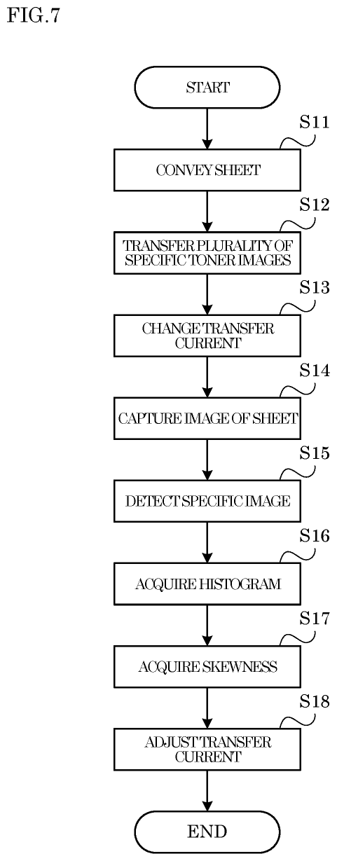

In the following, with reference to FIG. 7, a description is given of an example of the procedure of a transfer current adjustment process executed by the control portion 7 in the image forming apparatus 100, as well as a transfer current adjustment method of the present disclosure. Here, steps S11, S12, . . . represent numbers assigned to the processing procedures (steps) executed by the control portion 7. It is noted that the control portion 7 executes the transfer current adjustment process when the conveyance timing has arrived.

<Step S11>

First, in step S11, the control portion 7 causes a sheet stored in the sheet feed cassette to be conveyed along the conveyance path R1.

<Step S12>

In step S12, the control portion 7 sequentially transfers a plurality of specific toner images to the sheet that is conveyed by the process of step S11. Here, the process of step S12 is an example of a transfer step of the present disclosure, and is executed by the transfer processing portion 51 of the control portion 7.

Specifically, the control portion 7 forms the plurality of first toner layers in alignment along the rotation direction D4 (see FIG. 3) on the photoconductor drum 31 of the image forming unit 22, and sequentially transfers the plurality of first toner layers onto the intermediate transfer belt 26. In addition, the control portion 7 forms the plurality of second toner layers in alignment along the rotation direction D4 (see FIG. 3) on the photoconductor drum 31 of the image forming unit 23, and sequentially transfers the plurality of second toner layers onto the plurality of first toner layers formed on the intermediate transfer belt 26, respectively. This forms the plurality of specific toner images in alignment along the rotation direction D5 (see FIG. 3) on the intermediate transfer belt 26. Subsequently, the control portion 7 sequentially transfers the plurality of specific toner images from the intermediate transfer belt 26 to a sheet conveyed by the sheet feed portion 4.

<Step S13>

In step S13, the control portion 7 changes the current value of the secondary transfer current that is supplied to the secondary transfer roller 27, each time a specific toner image is transferred by the process of step S12. Here, the process of step S13 is an example of a change step of the present disclosure, and is executed by the change processing portion 52 of the control portion 7.

Specifically, the control portion 7 increases, in units of the reference amount, the current value of the secondary transfer current that is supplied from the power supply 41, each time a specific toner image is transferred by the process of step S12.

<Step S14>

In step S14, the control portion 7 acquires, by using the image capturing portion 42, the captured image of the sheet to which the plurality of specific toner images have been transferred. Here, the process of step S14 is an example of a first acquisition step of the present disclosure, and is executed by the first acquisition processing portion 53 of the control portion 7.

<Step S15>

In step S15, the control portion 7 detects the specific image from the captured image of the sheet acquired in step S14. Here, the process of step S15 is an example of a detection step of the present disclosure, and is executed by the detection processing portion 54 of the control portion 7.

Specifically, the control portion 7 detects, as the specific image, a colored area having the same shape as the specific toner image included in the captured image of the sheet.

<Step S16>

In step S16, the control portion 7 acquires, for each of specific images detected in step S15, a histogram of gradation values of a color mixture of the second color and the third color in the pixels included in the specific image.

Specifically, the control portion 7 acquires a histogram of gradation values of R for each specific image, based on gradation values of R of the pixels included in the specific image detected in step S15.

<Step S17>

In step S17, the control portion 7 acquires, for each of the histograms acquired in step S16, the skewness of each histogram. Here, the processes of steps S16 and S17 are an example of a second acquisition step of the present disclosure, and are executed by the second acquisition processing portion 55 of the control portion 7.

<Step S18>

In step S18, the control portion 7 adjusts the secondary transfer current based on: the skewness for each specific image acquired by the process of step S17; and the current value of the secondary transfer current corresponding to the skewness. Here, the processes of step S18 is an example of an adjustment step of the present disclosure, and is executed by the adjustment processing portion 56 of the control portion 7.

For example, each time a skewness is acquired by the process of step S17, the control portion 7 determines the unevenness depth level corresponding to the skewness.

In addition, the control portion 7 sets, as a new current value of the secondary transfer current, the lowest current value among current values of the secondary transfer current for the unevenness depth level “1”.

As described above, in the image forming apparatus 100, a plurality of specific toner images are sequentially transferred to a sheet, wherein each of the plurality of specific toner images includes: the first toner layer of the first color formed on the intermediate transfer belt 26; and the second toner layer of the second color formed on the first toner layer. In addition, each time a specific toner image is transferred, the current value of the secondary transfer current is changed. In addition, a skewness of a histogram of gradation values of a color mixture of the second color and the third color is acquired for each of the specific images included in the captured image of the sheet to which the plurality of specific toner images have been transferred. Furthermore, the secondary transfer current is adjusted based on: the skewness acquired for each specific image; and the current value of the secondary transfer current corresponding to the skewness. This makes it possible to adjust the current value of the secondary transfer current to a minimum current value capable of restricting degradation of the formed image. With this configuration, when an image is formed on a sheet with an uneven surface, it is possible to restrict degradation of the formed image, as well as restrict generation of an abnormal image.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a transfer portion configured to transfer a toner image formed on an image-carrying member to a sheet;
a transfer processing portion configured to, by using the transfer portion, sequentially transfer, to the sheet, a plurality of specific toner images which each include: a first toner layer of a first color formed on the image-carrying member; and a second toner layer of a second color formed on the first toner layer, wherein the first color is any one of colors C, M, and Y, and the second color is any one of the colors C, M, and Y and is different from the first color;
a change processing portion configured to change a current value of a transfer current that is supplied to the transfer portion, each time a specific toner image is transferred by the transfer processing portion;
a first acquisition processing portion configured to acquire a captured image of the sheet;
a detection processing portion configured to detect a specific image that corresponds to each specific toner image included in the captured image of the sheet acquired by the first acquisition processing portion;
a second acquisition processing portion configured to acquire, for each of specific images detected by the detection processing portion, a skewness of a histogram of gradation values of a color mixture of the second color and a third color in pixels included in each of the specific images detected by the detection processing portion, the third color being a color different from the first color and the second color among the colors C, M, and Y; and
an adjustment processing portion configured to adjust the transfer current based on: the skewness acquired by the second acquisition processing portion for each of the specific images; and a current value of the transfer current corresponding to the skewness.

2. The image forming apparatus according to claim 1, further comprising
an image capturing portion configured to capture an image of the sheet at a downstream of a transfer position in a sheet conveyance path along which the sheet is conveyed via the transfer position where the toner image is transferred by the transfer portion, wherein
the first acquisition processing portion acquires, by using the image capturing portion, the captured image of the sheet to which the plurality of specific toner images have been transferred by the transfer processing portion.

3. A transfer current adjustment method executed in an image forming apparatus including a transfer portion configured to transfer a toner image formed on an image-carrying member to a sheet, the transfer current adjustment method comprising:
a transfer step of, by using the transfer portion, sequentially transferring, to the sheet, a plurality of specific toner images which each include: a first toner layer of a first color formed on the image-carrying member; and a second toner layer of a second color formed on the first toner layer, wherein the first color is any one of colors C, M, and Y, and the second color is any one of the colors C, M, and Y and is different from the first color;
a change step of changing a current value of a transfer current that is supplied to the transfer portion, each time a specific toner image is transferred in the transfer step;
a first acquisition step of acquiring a captured image of the sheet;
a detection step of detecting a specific image that corresponds to each specific toner image included in the captured image of the sheet acquired in the first acquisition step;
a second acquisition step of acquiring, for each of specific images detected in the detection step, a skewness of a histogram of gradation values of a color mixture of the second color and a third color in pixels included in each of the specific images detected in the detection step, the third color being a color different from the first color and the second color among the colors C, M, and Y; and
an adjustment step of adjusting the transfer current based on: the skewness acquired in the second acquisition step for each of the specific images; and a current value of the transfer current corresponding to the skewness.
